(19) United States
(12) Patent Application Publication
(10) Pub. No.: US 2026/0127371 A1
(43) Pub. Date: May 7, 2026

(54) MODEL TRAINING AND TEXT GENERATION METHOD, AND RELATED DEVICE

(71) Applicant: MASHANG CONSUMER FINANCE CO., LTD., Chongqing (CN)

(72) Inventor: Quan LU, Chongqing (CN)

(21) Appl. No.: 19/093,133

(22) Filed: Mar. 27, 2025

(30) Foreign Application Priority Data
Nov. 7, 2024 (CN) 202411582040.1

(51) Int. Cl. G06F 40/289; G06N 20/00

(52) U.S. Cl. CPC G06F 40/289; G06N 20/00

(57) ABSTRACT

In a model training method, a first set of texts is generated based on a conversation of a first user. The first set of texts indicate a tendency of the first user in response to the conversation. A first score of each text of the first set of texts is determined based on behavior data of the first user. The first score indicates a correlation between the tendency of the first user and a behavior of the first user in response to the conversation. The first set of texts is combined based on the first score of each text, to obtain a plurality of pairs of texts. A first prediction model is trained based on the plurality of pairs of texts.

### RELATED APPLICATION

The present application claims priority to Chinese Patent Application No. 202411582040.1 filed on Nov. 7, 2024, which is hereby incorporated by reference in its entirety.

### FIELD OF THE TECHNOLOGY

This disclosure relates to the field of natural language processing technologies, including to a model training method, a text generation method, and a related device.

### BACKGROUND OF THE DISCLOSURE

A model, for example, a large language model (LLM), has an excellent capability of summarizing text information, and can extract and refine key information elements from a large quantity of raw texts, for further processing into standard structured data, or to help in a next classification or prediction task.

However, the model summarizes the text information to minimize information compression loss, and lacks the capability to summarize a particular task. For example, in some service scenarios, the model cannot accurately summarize a behavior tendency of a user from a conversation, affecting the subsequent service processing.

### SUMMARY

Aspects of this disclosure provide a model training method, a text generation method, and a related device, to enable a model to automatically learn to summarize a behavior tendency of a user more quickly and accurately from a conversation record of the user.

In an aspect of this disclosure, a model training method is provided. In the method, a first set of texts is generated based on a conversation of a first user. The first set of texts indicates a tendency of the first user in response to the conversation. A first score of each text of the first set of texts is determined based on behavior data of the first user. The first score indicates a correlation between the tendency of the first user and a behavior of the first user in response to the conversation. The first set of texts is combined based on the first score of each text, to obtain a plurality of pairs of texts. A first prediction model is trained based on the plurality of pairs of texts.

In an aspect of this disclosure, a text generation method is provided. In the method, a sixth text is generated based on a first model and a conversation record of a second user. The sixth text indicates a behavior tendency of the second user. A first phrase is extracted from a sentence in the sixth text, and a first question text is generated based on the sentence to which the first phrase belongs. The first question text indicates a question with the first phrase as an answer. The first phrase is checked based on the first question text. A seventh text is obtained based on a check result of the first phrase.

In an aspect of this disclosure, a model training apparatus including processing circuitry is provided. The processing circuitry is configured to generate a first set of texts based on a conversation of a first user. The first set of texts indicates a tendency of the first user. The processing circuitry is configured to determine a first score of each text of the first set of texts based on behavior data of the first user. The first score indicating a correlation between the tendency of the first user and a behavior of the first user in response to the conversation. The processing circuitry is configured to combine the first set of texts based on the first score of each text, to obtain a plurality of pairs of texts. The processing circuitry is configured to train a first prediction model based on the plurality of pairs of texts.

In an aspect of this disclosure, a text generation apparatus including processing circuitry is provided. The processing circuitry is configured to generate a sixth text based on a first model and a conversation record of a second user. The sixth text indicates a behavior tendency of the second user. The processing circuitry is configured to extract a first phrase from a sentence in the sixth text, and generate a first question text based on the sentence to which the first phrase belongs. The first question text indicates a question with the first phrase as an answer. The processing circuitry is configured to check the first phrase based on the first question text. The processing circuitry is configured to obtain a seventh text based on a check result of the first phrase.

In an aspect of this disclosure provides an electronic device, including a processor and a memory. The memory is configured to store instructions executable by the processor. The processor being configured to execute the instructions in the memory to perform any of the methods according to this disclosure.

In an aspect of this disclosure provides a non-transitory computer-readable storage medium. The non-transitory computer-readable storage medium stores instructions which when executed by a processor, cause the processor to perform any of the methods according to this disclosure.

In an aspect of this disclosure provides a computer program product. The computer program product includes a non-transitory computer-readable storage medium having a computer program stored thereon. The computer program is executable to enable a computer to perform some or all of operations in any of the methods provided in this disclosure.

According to some aspects of the present disclosure, a behavior tendency of a first user is summarized from a conversation record of the first user by using a to-be-trained first model, to obtain a plurality of first texts. An effect of summarizing the behavior tendency from the conversation record by the first model may be directly or indirectly observed through an actual behavior of the first user. In view of this, a first score of each of the first texts is determined based on behavior data of the first user, to indicate quality of each of the first texts, in other words, descriptions of each of the first texts for the behavior tendency is more accurate. Further, every two of the plurality of first texts are combined based on the first score of each of the first texts, to obtain a plurality of text pairs, so as to represent a magnitude relationship between scores of the first texts. The magnitude relationship between every two first texts can objectively and accurately reflect a preference of a user for a high-quality first text. Therefore, training the first model based on the plurality of text pairs can help the first model to automatically learn such a preference from each of the text pairs, and enhance a capability of the first model to summarize the behavior tendency of the user from the conversation record. In addition, training data of the first model may not need to be generated by using manual labeling and an additional rewarding model, to minimize factors such as a labeling error and insufficient data amount of labeled data from affecting a training effect of the first model while improving training efficiency and saving resources. In this way, the first model can summarize the behavior tendency of any user quickly and accurately from the conversation record of the user.

### BRIEF DESCRIPTION OF THE DRAWINGS

The accompanying drawings described herein are used to provide a further understanding of this disclosure. Examples and descriptions thereof are used to explain this disclosure, and do not limit the scope of this disclosure. In the accompanying drawings:

FIG. 1 is a schematic flowchart of a model training method according to an aspect of this disclosure.

FIG. 2 is a schematic flowchart of a text generation method according to an aspect of this disclosure.

FIG. 3 is a schematic flowchart of a text generation method according to an aspect of this disclosure.

FIG. 4 is a schematic diagram of a structure of a model training apparatus according to an aspect of this disclosure.

FIG. 5 is a schematic diagram of a structure of a text generation apparatus according to an aspect of this disclosure.

FIG. 6 is a schematic diagram of a structure of an electronic device according to an aspect of this disclosure.

### DETAILED DESCRIPTION

Examples of technical solutions of this disclosure are described below with reference to the accompanying drawings. The described aspects are merely some rather than all of aspects of this disclosure. Other aspects shall fall within the protection scope of this disclosure.

Descriptions of terms in this disclosure are provided as examples only and are not intended to limit the scope of the disclosure.

The terms “first”, “second”, and the like are used to distinguish similar objects, but are not used to describe a specific sequence or order. Such used data is interchangeable where appropriate, so that aspects of this disclosure described can be implemented in an order other than those illustrated or described here. In addition, “and/or” means at least one of the connected objects, and the character “/” generally indicates an “or” relationship between the associated objects.

Description of related terms:
Universal sentence encoder (USE): A model for generating a sentence-level vector representation. A sentence is input, and a vector with a fixed length is output. The vector may be directly configured for various downstream tasks, to provide an easy-to-use method with powerful functions to process sentence-level semantic information. The algorithm provides universal sentence embedding by using a deep learning model of a transform architecture. The model is trained on a large-scale multi-task data set, and includes supervised and unsupervised tasks, to ensure diversity and universality of embedding.
Conditional random field (CRF): A probability model for a sequence labeling task and is suitable for an entity extraction task. When mutual dependency between a context and a label needs to be considered, with reference to a deep learning model, for example, a long short-term memory (LSTM) network, an effect can be further improved, especially when a complex language structure is processed.

A model summarizes text information from a perspective of minimizing an information compression loss, and lacks a capability of summarizing a particular task. For example, in some service scenarios, the model cannot accurately summarize a behavior tendency of a user from a conversation record of the user, affecting subsequent service processing effects.

Therefore, an aspect of this disclosure provides a model training method. First, a behavior tendency of a first user is summarized from a conversation record of the first user by using a to-be-trained first model, to obtain a plurality of first texts. An effect of summarizing the behavior tendency from the conversation record by the first model may be directly or indirectly observed through an actual behavior of the first user. In view of this, a first score of each of the first texts is determined based on behavior data of the first user, to indicate quality of each of the first texts, in other words, whether descriptions of each of the first texts for the behavior tendency is accurate. Further, every two of the plurality of first texts are combined based on the first score of each of the first texts, to obtain a plurality of text pairs, so as to represent a magnitude relationship between scores of the first texts. The magnitude relationship between every two first texts can objectively and accurately reflect a preference of a human being for a high-quality first text. Therefore, training the first model based on the plurality of text pairs helps the first model to automatically learn such a preference from each of the text pairs, and enhances a capability of the first model to summarize the behavior tendency of the user from the conversation record. In addition, training data of the first model does not need to be generated by using manual labeling and an additional rewarding model, to prevent factors such as a labeling error, insufficient data amount of labeled data, and an error of a reward model from affecting a training effect of the first model while improving training efficiency and saving resources. In this way, the first model can summarize the behavior tendency of any user quickly and accurately from the conversation record of the user.

Based on the trained first model, an aspect of this disclosure further provides a text generation method. A behavior tendency of any user is summarized quickly and accurately from a conversation record of the user by using a first model, to provide reliable data support for subsequent service processing.

The model training method and the text generation method provided in aspects of this disclosure may be performed by an electronic device, and specifically, may be performed by a processor of the electronic device. The electronic device may include a terminal device, for example, including but not limited to, a smartphone, a tablet computer, a notebook computer, a desktop computer, a smart voice interaction device, a smart household appliance, a smartwatch, a vehicle-mounted terminal, an aerial vehicle, and the like. Alternatively, the electronic device may include a server, for example, an independent physical server, or may be a server cluster or a distributed system formed by a plurality of physical servers, or may be a cloud server providing cloud computing services.

The following describes examples of technical solutions in further detail with reference to the accompanying drawings.

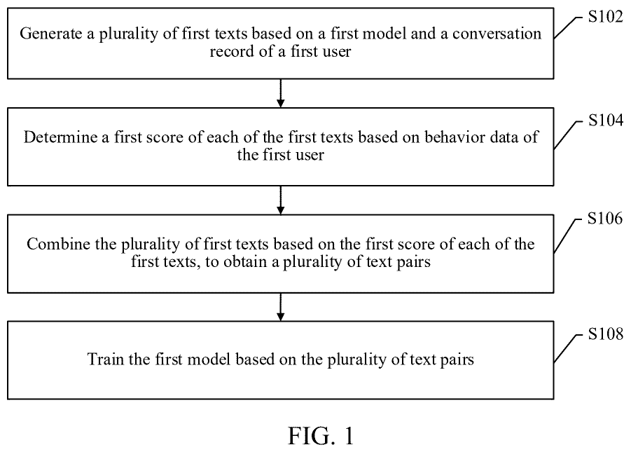

FIG. 1 is a schematic flowchart of a model training method according to an aspect of this disclosure. The method includes the following operations:
S102: Generate a plurality of first texts based on a first model and a conversation record of a first user.

The conversation record of the first user is configured for describing a conversation between the first user and a conversation party (for example, an agent), and may include k-round conversation texts between the first user and the conversation party, k being a positive integer. For example, in an information recommendation scenario, the conversation record of the first user is configured for describing a conversation between a recommender and the first user in a process of recommending a product to the first user. For another example, in a task-type conversation scenario, the conversation record of the first user is configured for describing a conversation that is of the first user that is related to a task.

The first model may use various large language models having a text information summarization capability, for example, GPT-4, Claude-3, Gemini-2, Liama-3, Mistral, or a self-developed large language model, which is not limited in aspects of this disclosure.

The first text is obtained by summarizing the conversation record of the first user by using the text information summarization capability of the first model. The first text is configured for describing a behavior tendency of the first user. For example, in the information recommendation scenario, the first text is configured for describing a tendency of the first user to purchase a product after the conversation ends. As another example, in the task-type conversation scenario, the first text is configured for describing a tendency of the first user to perform a task after the conversation ends.

The plurality of first texts may be obtained by summarizing, in a plurality of rounds, the conversation record of the first user by using the first model. A summarization round may be set based on an actual requirement. A quantity of summarization rounds is equal to that of first texts, and one first text is obtained through each round of summarization.

In an example, in each round of summarization process, a summarization prompt and the conversation record of the first user in a current round are input into the first model, to obtain a first text summarized in this round. The summarization prompt used in each round of summarization may vary. For example, a summarization prompt in a zero-sample form is used in a first round of summarization, and a summarization prompt in a form of a chain of thought is used in a second round of summarization. Alternatively, a summarization prompt that does not include a restriction condition is used in the first round of summarization, and a summarization prompt including a restriction condition is used in the second round of summarization.

For example, the summarization prompt used in the first round of summarization are as follows:
“Assuming that you are a marketing expert deeply skilled in user psychological analysis, please generate, by using the following content of a plurality of rounds of conversations, a summary of the user's intention to purchase the product A in the future one month.”

The summarization prompt used in the second round of summarization are as follows:
“Assuming that you are a marketing expert deeply skilled in user psychological analysis, please generate, by using the following content of a plurality of rounds of conversations, a summary of the user's intention to purchase the product A in the future one month. The content of the summary needs to include all key information helping subsequent analysis of the user's intention to purchase, and focus on the feedback emotion expressed by the user in the conversation, confusion about the product, difficulty in purchasing, and whether the use expresses the intention in subsequent communication and contact.”

A summarization prompt used in a third round of summarization are as follows:
“Assuming that you are a marketing expert deeply skilled in user psychological analysis, please generate, by using the following content of a plurality of rounds of conversations, a summary of the user's intention to purchase the product A in the future one month. The content of the summary needs to include all key information helping subsequent analysis of the user's intention to purchase, and focus on the feedback emotion expressed by the user in the conversation, confusion about the product, difficulty in purchasing, and whether the use expresses the intention in subsequent communication and contact. The summary needs to be succinct with explicit views and hit the point.”

In another example, in each round of summarization process, a summarization prompt and the conversation record of the first user are input into the first model, to obtain a first text summarized in this round. Then, a temperature parameter (i.e., a parameter controls creativity or randomness of the model output) of the first model is adjusted. The same summarization prompt may be used in each round of summarization, but the temperature parameter of the first model in each round of summarization varies, to increase diversity of the first text output by the first model.

Some implementations of the foregoing S102 are shown above. The foregoing S102 may alternatively be implemented in another manner, which is not limited in aspects of this disclosure.

There may be a plurality of first users, and a quantity of first users is not limited in this disclosure. When there are a plurality of first users, for each of the first users, a plurality of first texts of the first user is generated based on a conversation record of the first user and the first model, and each of the first texts is configured for describing a behavior tendency of the first user.

For example, a customer relationship management (CRM) system uses conversation records of n first users in total. The conversation record of each of the first users includes k-round conversation texts. Using a u^{th} first user as an example, a conversation record of the u^{th} first user includes the following k-round conversation texts: Du-1, Du-2, . . . , and Du-k. Assuming that a summarization target is whether each of the first users has a tendency to purchase a recommended product after a conversation ends, three rounds of summarization are performed on the conversation record of the u^{th} first user based on the first model, to obtain three first texts of the u^{th} first user, which are denoted as Su-1, Su-2, and Su-3.
S104: Determine a first score of each of the first texts based on behavior data of the first user.

The behavior data of the first user is configured for describing a behavior of the first user. Still using the foregoing information recommendation scenario as an example, the behavior data is configured for describing whether the first user purchases the recommended product after the conversation ends.

Each of the first texts has a corresponding first score. The first score of the first text is configured for representing quality of the first text, and reflects whether descriptions of the behavior tendency in the first text are accurate.

In this aspect of this disclosure, the foregoing S104 may be implemented in various manners.

In an implementation, the foregoing S104 includes the following operations:
S141: Determine a first label of each of the first texts based on the behavior data.

The first label represents a type of a behavior of the first user. For example, the type of the behavior may include a first type and a second type, and a 0/1 label may be used for the first label, 0 representing the first type, and 1 representing the second type. It is assumed that the summarization target is to summarize, in the conversation record of the first user, the tendency of the first user to generate the first behavior after the conversation ends. If it is determined, based on the behavior data, that the first user generates a first behavior after the conversation ends, it is determined that the type of the behavior of the first user is the second type, and the value 1 is assigned to the first label of each of the first texts. If it is determined, based on the behavior data, that the first user does not generate a first behavior after the conversation ends, it is determined that the type of the behavior of the first user is the first type, and the value 0 is assigned to the first label of each of the first texts.

Using the foregoing information recommendation scenario as an example, it is assumed that the summarization target is to summarize, in the conversation record of the first user, whether the first user has a tendency to purchase the recommended product after the conversation ends. If it is determined, based on the behavior data, that the first user purchases the recommended product after the conversation ends, it is determined that the type of the behavior of the first user is the second type, and the value 1 is assigned to the first label of each of the first texts. If it is determined, based on the behavior data, that the first user does not purchase the recommended product after the conversation ends, it is determined that the type of the behavior of the first user is the first type, and the value 0 is assigned to the first label of each of the first texts.

During actual application, a discrete label in another form may alternatively be used for the first label, and a form of the first label is not limited in aspects of this disclosure.

In addition, when there are a plurality of first users, for each of the first users, a first label of each of the first texts of the first user is determined based on behavior data of the first user. First labels of all of the first texts of the same first user are the same.

Using a u^{th} first user as an example, if the first user purchases a recommended product after a conversation ends, first labels of all of the first texts Su-1 to Su-3 of the first user are 1. If the first user does not purchase the recommended product after the conversation ends, the first labels of all of the first texts Su-1 to Su-3 of the first user are all 0.
S142: Cluster sentences in the plurality of first texts, to obtain a cluster.

There may be a plurality of clusters.

Each cluster includes at least one sentence. Sentences in the same cluster may belong to the same first text, or may belong to different first texts. For example, a cluster 1 includes a sentence 1 and a sentence 2, a cluster 2 includes a sentence 3 and a sentence 4. Both the sentence 1 and the sentence 2 belong to a text 1, the sentence 3 belongs to the text 1, and the sentence 4 belongs to a text 2.

The clustering sentences in the first texts means classifying similar sentences in the sentences in all the first texts into one type to form a cluster. When there are a plurality of first users, the clustering in this aspect of this disclosure is to cluster sentences in first texts of all of the first users.

The clustering the sentences in the first texts may be implemented in various appropriate manners, which is not limited in aspects of this disclosure.

In an example, the sentences in the first texts are encoded, to obtain sentence vectors of the sentences. The sentences in the first texts are clustered based on similarity between the sentence vectors of the sentences, to obtain a cluster.

For example, there are three first texts in total, that is, Su-1, Su-2, and Su-3. Assuming that Su-1 includes 10 sentences, Su-2 includes eight sentences, and Su-3 includes nine sentences, the 27 sentences are clustered, to obtain a cluster.

For each sentence, the sentence is encoded by using an encoder. For example, the sentence is encoded by using a USE, to obtain a sentence vector of the sentence. Then, a cosine distance between sentence vectors of every two sentences is determined, and is used as similarity between the every two sentences. Further, sentences whose similarities are greater than a similarity threshold (for example, 0.99) are classified into one type, to obtain a cluster.

For ease of subsequent analysis, after the cluster is obtained, a reverse index may be further established for the cluster. The reverse index is for quickly locating a sentence vector of a sentence in the cluster and a first text to which the sentence belongs.

For example, the first text Su-1 includes three sentences, and sentence vectors of the three sentences are respectively Su1-e1, Su1-e2, and Su1-e3. The first text Su-2 includes two sentences, and sentence vectors of the two sentences are respectively Su2-e1 and Su2-e3. Assuming that sentence vectors of sentences in a cluster are respectively Su1-e1 and Su2-e1, a reverse index being (Su-1, Su-2) is established for the cluster.

In the foregoing manner, the sentence vectors of the sentences imply abundant semantic information. The sentences in the first texts are clustered based on the similarity between the sentence vectors of the sentences, to improve clustering accuracy, and ensure that sentences in the same cluster are semantically similar, so as to help improve accuracy of subsequently scoring each of the first texts.

In another example, a text similarity comparison technology in the art may be used to compare every two sentences, to obtain similarity between the every two sentences. Then, the sentences in the first texts are clustered based on the similarity between the every two sentences, to obtain a cluster. The text similarity comparison technology may include, for example, but is not limited to at least one of the following technologies: similarity comparison based on a bag of words (BoW) model, keyword comparison, and the like.
S143: Determine the first score of each of the first texts based on the first label of the first text and a first text to which each of the sentences in the cluster belongs.

Considering that a higher correlation between a cluster and a first label of a first text to which a sentence in the cluster belongs indicates a higher correlation between whether the sentence in the first text belongs to the cluster and a type of a behavior of the first user, a correlation between the cluster to which the sentence in the first text belongs and the behavior generated by the first user may objectively and accurately reflect whether the behavior tendency described by the first text is accurate.

For example, assuming that a text 1 includes a sentence 1 and a sentence 2, after clustering, the sentence 1 and the sentence 2 belong to a cluster 1, and in this case, a higher correlation between the cluster 1 and the text 1 indicates a larger correlation between whether a sentence in the text 1 belongs to the cluster 1 and a behavior type represented by a first label of the text 1.

In view of this, the foregoing S143 may include the following operations: Operation A1: Determine a second score of the cluster based on the first label of the first text and the first text to which the sentence in the cluster belongs. Operation A2: Determine, as the first score of the first text, a sum of second scores of clusters to which the sentences in the first texts belong.

In the foregoing operation A1, the second score of the cluster indicates a correlation between the first text to which the sentence in the cluster belongs and the first label of the first text, and may specifically indicate a correlation between whether the sentence in the first text belongs to the cluster and the first label of the first text, or a correlation between whether the sentence in the first text belongs to the cluster and the behavior generated by the first user.

More specifically, in the foregoing operation A1, the second score of each cluster is determined in the following manner: determining, from the plurality of first texts, a second text, a third text, a fourth text, and a fifth text corresponding to the cluster; determining, based on a quantity of second texts, a quantity of third texts, a quantity of fourth texts, and a quantity of fifth texts, a correlation coefficient between the cluster and the first label of the first text to which the sentence in the cluster belongs; and determining the second score of the cluster based on the correlation coefficient.

For each cluster, a sentence in the second text corresponding to the cluster does not belong to the cluster, and a first label of the second text indicates that the type of the behavior of the first user is the first type, for example, the first user does not generate a behavior. A sentence in the third text corresponding to the cluster does not belong to the cluster, and a first label of the third text indicates that the type of the behavior of the first user is the second type, for example, the first user generates a behavior. A sentence in the fourth text corresponding to the cluster belongs to the cluster, and a first label of the fourth text indicates that the type of the behavior of the first user is the first type. A sentence in the fifth text corresponding to the cluster belongs to the cluster, and a first label of the fifth text indicates that the type of the behavior of the first user is the second type.

Still using the foregoing information recommendation scenario as an example, it is assumed that the behavior of the first type means that the first user does not purchase the recommended product, and the behavior of the second type means that the first user purchases the recommended product. For a cluster λ, a quantity of second texts, a quantity of third texts, a quantity of fourth texts, and a quantity of fifth texts corresponding to the cluster are determined, and details are shown in Table 1. The sentence in the second text does not belong to the cluster λ (that is, λ=0), the first user does not purchase the recommended product after the conversation ends (that is, the first label is 0), and the quantity of second texts is denoted as A₀₀. The sentence in the third text does not belong to the cluster λ (that is, λ=0), the first user purchases the recommended product after the conversation ends (that is, the first label is 1), and the quantity of third text is denoted as A₀₁. The sentence in the fourth text belongs to the cluster λ (that is, λ=1), the first user does not purchase the recommended product after the conversation ends (that is, the first label is 0), and the quantity of fourth text is denoted as A₁₀. The sentence in the fifth text belongs to the cluster λ (that is, λ=1), the first user purchases the recommended product after the conversation ends (that is, the first label is 1), and the quantity of fifth text is denoted as A₁₁.

TABLE 1

| | First label is 0 | First label is 1 |
|---|---|---|
| λ = 0 | A₀₀ | A₀₁ |
| λ = 1 | A₁₀ | A₁₁ |

Based on the foregoing Table 1, a correlation coefficient between the cluster A and a first label of a first text to which a sentence in the cluster A belongs is determined by using the following formula (1):

$$ϕ = ( {A}_{00} * {A}_{11} - {A}_{10} * {A}_{01} ) / \{ ( {A}_{00} + {A}_{10} ) * ( {A}_{10} + {A}_{11} ) * ( {A}_{11} + {A}_{01} ) * ( {A}_{01} + {A}_{00} ) \} \qquad ( 1 )$$

φ represents the correlation coefficient between the cluster λ and the first label of the first text to which the sentence in the cluster λ belongs, and the correlation coefficient is a value between −1 and 1.

Further, a second score of the cluster A is determined by using the following formula (2):

$${T}_{λ} = \vert ϕ ( λ , S ) \vert \qquad ( 2 )$$

T_{λ} represents the second score of the cluster λ, and S represents a set including the first text to which the sentence in the cluster λ belongs. A larger T_{λ} indicates a higher correlation between whether the sentence in each of the first texts belongs to the cluster λ and the first label of each of the first texts.

Further, the first score of each of the first texts is determined by using the following formula (3):

$${R}_{{S}_{i}} = {\sum }_{λ ∈ {S}_{i}} {T}_{λ} \qquad ( 3 )$$

R_{S}_{ᵢ} represents a first score of any first text, and λ∈Sᵢ represents a cluster to which a sentence in the first text belongs. A higher first score of the first text indicates better quality of the first text and a more accurate behavior tendency described by the first text.

In the foregoing implementation, a summarization effect of the behavior tendency summarized by the first model from the conversation record may be directly or indirectly observed through an actual behavior of the first user, and the actual behavior of the first user may be accurately reflected by the behavior data of the first user. In view of this, each of the first texts of the first user is labeled with a corresponding first label based on the behavior data of the first user, to indicate the type of the behavior of the first user, and then similar sentences are classified into one type by clustering. Finally, the first label of each of the first texts and a first text to which the sentence in the cluster belongs are analyzed, so that the correlation between the cluster to which the sentence in the first text belongs and the first label of the first text can be determined. The correlation may objectively and accurately reflect whether the behavior tendency described by the first text is accurate, to ensure accuracy of the first score generated for the first text and provide reliable and accurate data support for subsequent training of the first model. In this manner, the quality of each of the first texts does not need to be evaluated by using manual labeling and an additional reward model, and factors such as a labeling error and an error of a reward model are prevented from affecting a training effect of the first model while improving training efficiency and saving resources.

In another implementation, the foregoing S104 includes the following operations: performing, for each of the first texts, semantic parsing on the first text, to obtain semantics of the first text; and determining, based on the semantics of the first text, whether the behavior tendency described by the first text matches a behavior described by the behavior data of the first user, and determining the first score of the first text based on a matching degree.

The performing semantic parsing on the first text and matching with the behavior data may be implemented by using an existing large language model, or by using a semantic parsing and matching technology commonly used in the art, which is not limited in aspects of this disclosure.

Some implementations of S104 are shown above. The foregoing S104 may alternatively be implemented in another manner, which is not limited in aspects of this disclosure.
S106: Combine the plurality of first texts based on the first score of each of the first texts, to obtain a plurality of text pairs.

Each of the text pairs indicates a magnitude relationship between first scores of two first texts. Each of the text pairs is also referred to as a preference data pair or a preference data set, and can assistant the first model in automatically learning a preference of a human being for the first text. When there are a plurality of first users, for each of the first users, the plurality of first texts of the first user is combined based on the first score of each of the first texts of the first user, to obtain a plurality of text pairs corresponding to the first user.

Using a u^{th} first user as an example, a first text corresponding to the u^{th} first user includes Su-1, Su-2, and Su-3, and first scores of the three first texts are Tsu-1, Tsu-2, and Tsu-3 respectively. It is assumed that magnitude relationships between the three first scores are: Tsu-1>Tsu-2>Tsu-3. Three text pairs are obtained by combining the three first texts: {Su-1, Su-2}, {Su-2, Su-3}, and {Su-1, Su-3}. {Su-1, Su-2} indicates that Su-1 is superior to Su-2, {Su-2, Su-3} indicates that Su-2 is superior to Su-3, and {Su-1, Su-3} indicates that Su-1 is superior to Su-3.
S108: Train the first model based on the plurality of text pairs.

Specifically, full parameter fine tuning may be performed on the first model by using a direct preference optimization (DPO) algorithm. Therefore, implicit preference information of the plurality of text pairs may be used to guide training of the first model, so that the first model can automatically learn, from each of the text pairs, a preference of a human being for the first text, to generate a text meeting expectations of the human being, to accurately describe the behavior tendency of the first user.

Specifically, in an implementation, the foregoing S108 includes the following operations:
S181: Input, for each of the text pairs, the conversation record of the first user and the text pair into the first model for prediction, to obtain a first probability of a first text having a high first score in the text pair and a second probability of a first text having a low first score in the text pair. For example, the two probabilities could be combined into one probability with upper and lower limits.

For example, the conversation record and the text pair are input into the first model, and the first model selects one first text from the text pair. The operations are performed for a plurality of times, and the foregoing first probability and the foregoing second probability are predicted based on the quantity of operations and the first text selected by the first model in each operation.
S182: Input the conversation record of the first user and the text pair into a second model for prediction, to obtain a third probability of the first text having a high first score in the text pair and a fourth probability of the first text having a low first score in the text pair.

The second model is also referred to as a reference model. The second model may be a pre-trained language model that is pre-defined.

For example, the conversation record and the text pair are input into the second model, and the second model selects one first text from the text pair. The operations are performed for a plurality of times, and the foregoing third probability and the foregoing fourth probability are predicted based on the quantity of operations and the first text selected by the second model in each operation.
S183: Determine a fifth probability of the text pair based on a ratio of the first probability to the third probability and a ratio of the second probability to the fourth probability.

The fifth probability of the text pair indicates a probability that the first text having a high first score is superior to the first text having a low first score in the text pair.

In an example, the fifth probability of the text pair may be determined by using the following formula (4):

$$p ( {y}_{1} > {y}_{2} \vert x ) = \frac{1}{1 + exp ( βlog \frac{π ( {y}_{2} \vert x )}{{π}_{ref} ( {y}_{2} \vert x )} - βlog \frac{π ( {y}_{1} \vert x )}{{π}_{ref} ( {y}_{1} \vert x )} )} \qquad ( 4 )$$

p(y₁>y₂|x) represents the fifth probability of the text pair. y₁ represents the first text having a high first score in the text pair. y₂ represents the first text having a low first score in the text pair. π(y₁|x) represents a probability that, for a given conversation record, the first model outputs the first text having a high first score, in other words, the first probability of the first text having a high first score in the text pair. π_{ref}(y₁|x) represents a probability that, for the given conversation record, the second model outputs the first text having a high first score, in other words, the third probability of the first text having a high first score in the text pair. π(y₂|x) represents a probability that, for the given conversation record, the first model outputs the first text having a low first score, in other words, the second probability of the first text having a low first score in the text pair. π_{ref}(y₂|x) represents a probability that, for the given conversation record, the second model outputs the first text having a low first score, in other words, the fourth probability of the first text having a low first score in the text pair. β represents a hyperparameter.
S182: Determine a loss of the first model based on fifth probabilities of the plurality of text pairs.

In an example, the loss of the first model may be determined based on the fifth probabilities of the plurality of text pairs by using a binary cross entropy loss function.
S183: Adjust a parameter of the first model based on the loss.

In an example, the one or more parameters of the first model are adjusted by minimizing the loss of the first model and by using a back propagation algorithm.

The foregoing S181 to S183 are only a process of training the first model. During actual application, the first model may be trained for a plurality of times until a training stopping condition is satisfied. The training stopping condition may be set based on an actual requirement, for example, a quantity of times of training reaches a maximum quantity of times of training, or the loss of the first model converges, which is not limited in aspects of this disclosure.

In the model training method provided in one or more aspects of this disclosure, the behavior tendency of the first user is first summarized from the conversation record of the first user by using the to-be-trained first model, to obtain the plurality of first texts. An effect of summarizing the behavior tendency from the conversation record by the first model may be directly or indirectly observed through the actual behavior of the first user. In view of this, the first score of each of the first texts is determined based on the behavior data of the first user, to indicate quality of each of the first texts, in other words, whether descriptions of each of the first texts for the behavior tendency is accurate. Further, every two of the plurality of first texts are combined based on the first score of each of the first texts, to obtain the plurality of text pairs, so as to represent the magnitude relationship between scores of the first texts. The magnitude relationship between every two first texts can objectively and accurately reflect a preference of a human being for a high-quality first text. Therefore, training the first model based on the plurality of text pairs helps the first model to automatically learn such a preference from each of the text pairs, and enhances a capability of the first model to summarize the behavior tendency of the user from the conversation record. In addition, training data of the first model does not need to be generated by using manual labeling and an additional rewarding model, to prevent factors such as a labeling error, insufficient data amount of labeled data, and an error of a reward model from affecting a training effect of the first model while improving training efficiency and saving resources. In this way, the first model can summarize the behavior tendency of any user quickly and accurately from the conversation record of the user.

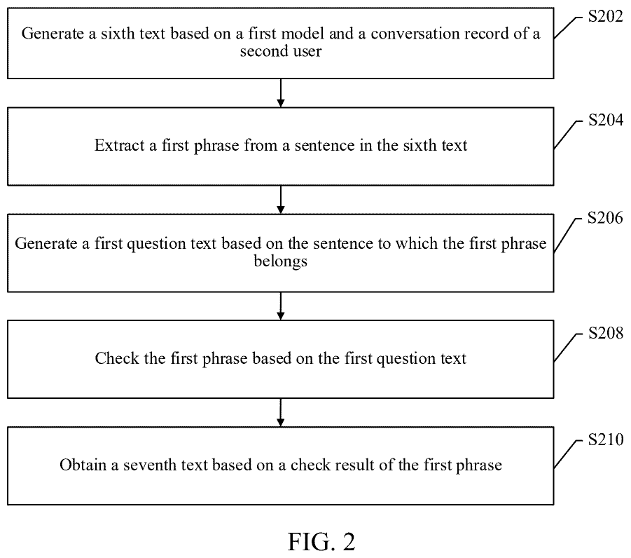

An aspect of this disclosure further provides a text generation method. FIG. 2 is a schematic flowchart of a text generation method according to an aspect of this disclosure. The method includes the following operations:
S202: Generate a sixth text based on a first model and a conversation record of a second user.

The second user is any user to be predicted. The conversation record of the second user is configured for describing a conversation between the second user and a conversation party, and may include k-round conversations between the second user and the conversation party, k being a positive integer. For example, in an information recommendation scenario, the conversation record of the second user is configured for describing a conversation between a recommender and the second user in a process of recommending a product to the second user.

The first model may be a general large language model, or may be obtained through training based on the model training method provided in aspects of this disclosure.

The sixth text is configured for describing a behavior tendency of the second user. For example, in the information recommendation scenario, the sixth text is configured for describing whether the second user purchases a product after the conversation ends. For another example, in a task-type conversation scenario, the sixth text is configured for describing a tendency of the second user to perform a task after the conversation ends.

In the foregoing S202, the sixth text is obtained by summarizing the conversation record of the second user by using a text information summarization capability of the first model.

In an implementation, the foregoing S202 includes the following operation: S221: Input a first prompt and the conversation record of the second user into the first model to obtain the sixth text.

The first prompt may be set based on an actual requirement. For example, the first prompt may be an instruction in a zero-sample form, or may be a prompt in a form of a chain of thought. For example, the first prompt is “assuming that you are a marketing expert deeply skilled in user psychological analysis, please generate, by using the following content of a plurality of rounds of conversations, a summary of the user's intention to purchase the product A in the future one month. The content of the summary needs to include all key information helping subsequent analysis of the user's intention to purchase, and focus on the feedback emotion expressed by the user in the conversation, confusion about the product, difficulty in purchasing, and whether the use expresses the intention in subsequent communication and contact. The summary needs to be succinct with explicit views and hit the point.”

In an aspect, the sixth text may include some unrealistic content generated due to model hallucinations, for example, some content that does not have corresponding conversation support in the conversation record of the second user. Especially when the first model is trained by using a text pair representing a magnitude relationship of scores between every two first texts, the first model is more inclined to output a text with a high score, and some content in the text may be hallucinations. Therefore, in the foregoing S202, the sixth text is further checked, to obtain the seventh text with high authenticity and reliability.

Specifically, as shown in FIG. 2, after the foregoing S202, the text generation method provided in this aspect of this disclosure may include the following operations:
S204: Extract a first phrase from a sentence in the sixth text.

In an example, for each of sentences in the sixth text, the sentence is divided into a plurality of phrases, and each of the phrases is the first phrase.

In another example, for each of the sentences in the sixth text, entity identification is performed on the sentence, to obtain an entity included in the sentence, and then a plurality of first phrases is extracted from the sentence based on the entity, each of the first phrases including an entity.

To improve entity identification accuracy, entity identification may be performed on the sentences by using a CRF model. For example, a sentence in the sixth text is “the attention of an applicant is attracted by emphasizing quick resource application, and various resource return selections are provided to alleviate the concern about the resource return pressure”, and includes entities “resource”, “applicant”, “resource return selection”, and “resource return pressure”. Therefore, four first phrases may be extracted from the sentence: {f1=“quick resource application”, f2=“attention of an applicant is attracted”, f3=“various resource return selections are provided”, f4=“alleviate the concern about the resource return pressure”}.
S206: Generate a first question text based on the sentence to which the first phrase belongs.

The first question text is configured for describing a question with the first phrase as an answer.

In an example, the sentence to which the first phrase belongs is analyzed by using an existing large language model (referred to as a third model below), to generate the first question text. Specifically, a corresponding prompt is generated based on the first phrase and the sentence to which the first phrase belongs. The prompt is configured for indicating to obtain, from the sentence to which the first phrase belongs, a question with the first phrase as an answer. Then, the prompt is input into the third model, to obtain the first question text. The third model may use various general language models having a text generation capability, for example, GPT-4, Claude-3, Gemini-2, Liama-3, and Mistral, which is not limited in aspects of this disclosure.

The foregoing sentence “the attention of an applicant is attracted by emphasizing quick resource application, and various resource return selections are provided to alleviate the concern about the resource return pressure” in the sixth text is used as an example. For the first phrase f1, the following prompts are generated based on the first phrase and the foregoing sentence:

“The first phrase is given as ‘quick resource application’, and the sentence to which the first phrase belongs is ‘the attention of an applicant is attracted by emphasizing quick resource application, and various resource return selections are provided to alleviate the concern about the resource return pressure’. Please generate a question following the following instruction:
1. The answer to the question generated needs to be directly found in the foregoing sentence.
2. The generated answer to the question needs to be the first phrase.
3. Do not generate an open-ended question with the answer exceeding the foregoing sentence.”

The foregoing prompts are input into the third model, to obtain the following first question text Qf1:
“What does the resource provider highlight to attract the attention of the applicant in the conversation?”

When there are a plurality of first phrases, each of the first phrase has a corresponding first question text. Each of the first phrases and the corresponding first question text may form a question-answer pair <Qfi, Afi>. Qfi represents the first question text, and Afi represents an answer to the first question text, that is, the corresponding first phrase ﬁ. For example, for each of the first phrases, the first question text corresponding to the first phrase is generated based on a sentence to which the first phrase belongs.
S208: Check the first phrase based on the first question text.

The checking the first phrase based on the first question text includes the following operations: checking whether the first phrase can be obtained from the conversation record of the second user; and determining, if the first phrase passes the check, that a fact supporting the first phrase can be found from the conversation record of the second user, in other words, the first phrase has no hallucination issue; or determining, if the first phrase does not pass the check, that a fact supporting the first phrase cannot be found from the conversation record of the second user, in other words, the first phrase has a hallucination issue.

In an example, the foregoing S208 includes the following operations:
obtaining, from the conversation record of the second user, an eighth text configured for answering the first question text; checking, by using the third model, whether the first phrase is obtained from the eighth text; and determining, if the first phrase is obtained from the eighth text, that the first phrase passes the check; or determining, if no first phrase is obtained from the eighth text, that the first phrase does not pass the check.

More specifically, a corresponding prompt is generated based on the conversation record of the second user and the first question text, the prompt being configured for indicating to obtain a text related to the first question text from the conversation record of the second user; and the prompt is input into the third model, to obtain an eighth text.

Further, a corresponding prompt is generated based on the eighth text and the first phrase, the prompt is configured for indicating to check whether the first phrase can be obtained from the eighth text; and the prompt is input into the third model, to obtain a check result of the first phrase.

For example, assuming that the first question text is “what does the resource provider highlight to successfully attract the attention of the applicant in historical marketing conversations?”, the conversation record of the second user includes conversation texts of k-round conversations, that is Du-1 to Du-k, and in this case, an example of the prompt is shown as follows:

“The historical marketing conversations with the second user are given as Du-1+Du-2+ . . . +Du-k in chronological order. What does the resource provider highlight to successfully attract the attention of the applicant in the historical marketing conversations? Please extract all related original conversations of the resource provider and responses of the second user. Please follow the following instructions:
1. Do not generate the answer, but extract the answer from the original conversation.
2. The extracted original conversation needs to be capable of directly answering the question.
3. The answer is used in the following format to represent each round of conversations: [resource provider #?:, second user #?:]
4. If no answer to the question is found in the original conversation, please output null, and do not make it up.”

The prompt is input into the third model, to obtain the eighth text. Further, the following prompts are generated based on the eighth text and the first phrase:
“The following conversation record of the second user is given:—Eighth text—

Whether the resource provider emphasizes ‘<first phrase>’ can be obtained from the conversation record? Please answer ‘yes’ or ‘no’.

The answer ‘yes’ indicates that the resource provider obviously emphasizes <first phrase> to the second user in the foregoing conversation record.

The answer ‘no’ indicates that the resource provider does not emphasize <first phrase> to the second user in the foregoing conversation record.”
S210: Obtain a seventh text based on a check result of the first phrase.

In an implementation, the foregoing S210 includes the following operation:
determining the sixth text as the seventh text if the first phrase passes the check.

When there are a plurality of first phrases, if all of the first phrases pass the check, it is determined that the sixth text has no hallucination issue, and further, the sixth text is determined as the seventh text.

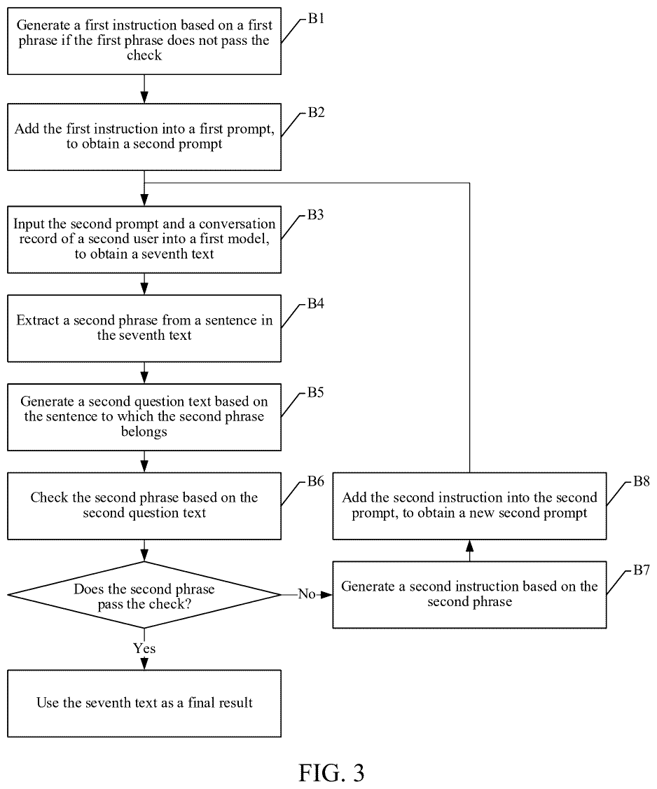

In another implementation, when the sixth text is obtained by inputting the first prompt and the conversation record of the second user into the first model, as shown in FIG. 3, the foregoing S210 may include the following operations:
Operation B1: Generate a first instruction based on the first phrase if the first phrase does not pass the check.

The first instruction is configured for instructing to generate the seventh text that does not include a first determining result.

Using an example in which the first phrase f1=“quick resource application”, the following first instruction is generated based on the first phrase f1=“quick resource application”:
“Do not add the following points that do not exist into the summary:
1. The resource provider emphasizes the quick resource application.”
Operation B2: Add the first instruction into the first prompt, to obtain a second prompt.

It is assumed that the first prompt is “assuming that you are a marketing expert deeply skilled in user psychological analysis, please generate, by using the following content of a plurality of rounds of conversations, a summary of the user's intention to purchase the product A in the future one month. The content of the summary needs to include all key information helping subsequent analysis of the user's intention to purchase, and focus on the feedback emotion expressed by the user in the conversation, confusion about the product, difficulty in purchasing, and whether the use expresses the intention in subsequent communication and contact. The summary needs to be succinct with explicit views and hit the point.” In this case, the foregoing first instruction is added into the first prompt, to obtain the second prompt shown below:

“Assuming that you are a marketing expert deeply skilled in user psychological analysis, please generate, by using the following content of a plurality of rounds of conversations, a summary of the user's intention to purchase the product A in the future one month. The content of the summary needs to include all key information helping subsequent analysis of the user's intention to purchase, and focus on the feedback emotion expressed by the user in the conversation, confusion about the product, difficulty in purchasing, and whether the use expresses the intention in subsequent communication and contact. The summary needs to be succinct with explicit views and hit the point.

Do not add the following points that do not exist into the summary:
1. The resource provider emphasizes the quick resource application.”
Operation B2 in S221 to S210 is repeated on the second prompt until the first phrase passes the check.
Operation B3: Input the second prompt and the conversation record of the second user into the first model, to obtain the seventh text.

In an example, the seventh text may be used as a final result.

In another example, as shown in FIG. 3, after the foregoing operation B3, the following operations are further included:
Operation B4: Extract a second phrase from a sentence in the seventh text.

A specific implementation of operation B4 is similar to the specific implementation of the foregoing operation S204, and details are not described again.
Operation B5: Generate a second question text based on the sentence to which the second phrase belongs.

A specific implementation of operation B5 is similar to the specific implementation of the foregoing operation S206, and details are not described again.
Operation B6: Check the second phrase based on the second question text.

A specific implementation of operation B6 is similar to the specific implementation of the foregoing operation S208, and details are not described again.
Operation B7: Generate a second instruction based on the second phrase if the second phrase does not pass the check.

A specific implementation of operation B7 is similar to the specific implementation of the foregoing operation B1, and details are not described again.
Operation B8: Add the second instruction into the second prompt, to obtain a new second prompt.

A specific implementation of operation B8 is similar to the specific implementation of the foregoing operation B2, and details are not described again.
Operation B9: Input the new second prompt into the first model, to obtain a new seventh text.

A specific implementation of operation B9 is similar to the specific implementation of the foregoing operation B3, and details are not described again.

The following operation B3 to operation B9 are repeated until the second phrase passes the check: directly using the seventh text as the final result if the second phrase passes the check, and ending the process.

In the foregoing implementation, if the first phrase does not pass the check, it indicates that the first phrase has a hallucination issue. In this case, the first instruction configured for deleting the first phrase from the generated text is added into the first prompt, to help the first model to self-correct the hallucination issue in the output text, so as to effectively reduce or eliminate the hallucination issue in the sixth text output by the first model, and ensure authenticity and reliability of the finally obtained seventh text.

In the text generation method provided on one or more aspects of this disclosure, the behavior tendency of any user is can be summarized quickly and accurately from the conversation record of the user by using the first model, to provide reliable data support for subsequent service processing.

Other aspects fall within the scope of the present disclosure. In some cases, actions or operations recorded in the claims may be performed in sequences different from those in aspects and an expected result may still be achieved. In addition, the processes depicted in the accompanying drawings are not necessarily performed in the specific order or successively to achieve an expected result. In some implementations, multitasking and parallel processing may be feasible or beneficial.

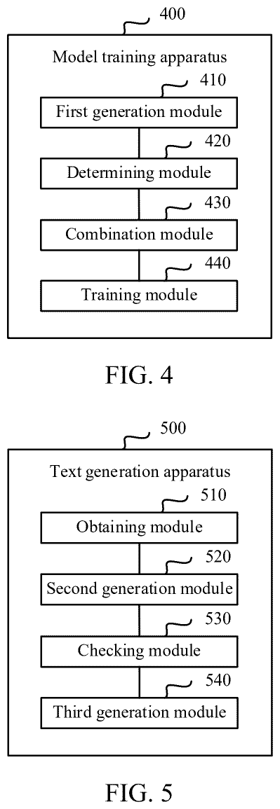

An aspect of this disclosure further provides a model training apparatus. FIG. 4 is a schematic diagram of a structure of a model training apparatus 400 according to an aspect of this disclosure. The apparatus 400 includes a first generation module 410, a determining module 420, a combination module 430, and a training module 440.

The first generation module 410 is configured to generate a plurality of first texts based on a first model and a conversation record of a first user, the first text being configured for describing a behavior tendency of the first user.

The determining module 420 is configured to determine a first score of each of the first texts based on behavior data of the first user.

The combination module 430 is configured to combine the plurality of first texts based on the first score of each of the first texts, to obtain a plurality of text pairs.

The training module 440 is configured to train the first model based on the plurality of text pairs.

In an aspect, the first texts include sentences. The determining module is configured to:
determine a first label of each of the first texts based on the behavior data, the first label indicating a type of a behavior of the first user;
cluster the sentences in the first texts, to obtain a cluster; and
determine the first score of each of the first texts based on the first label of the first text and a first text to which the sentences in the cluster belongs.

In an aspect, when clustering the sentences in the first texts to obtain the plurality of clusters, the determining module performs the following operations:
encoding the sentences in the first texts, to obtain sentence vectors of the sentences; and
clustering the sentences based on similarity between the sentence vectors of the sentences, to obtain the cluster.

In an aspect, when determining the first score of each of the first texts based on the first label of the first text and the first text to which each of the sentences in the cluster belongs, the determining module performs the following operations:
determining a second score of the cluster based on the first label of the first text and the first text to which the sentence in the cluster belongs, the second score indicating a correlation between the first text to which the sentence in the cluster belongs and the first label of the first text; and
determining, as the first score of the first text, a sum of second scores of clusters to which the sentences in the first texts belong.

In an aspect, when determining the second score of the cluster based on the first label of the first text and the first text to which the sentence in the cluster belongs, the determining module performs the following operations:
determining, from the plurality of first texts, a second text, a third text, a fourth text, and a fifth text corresponding to the cluster, a sentence in the second text not belonging to the cluster, and a first label of the second text indicating that the type of the behavior of the first user is a first type; a sentence in the third text not belonging to the cluster, and a first label of the third text indicating that the type of the behavior of the first user is a second type; a sentence in the fourth text belonging to the cluster, and a first label of the fourth text indicating that the type of the behavior of the first user is the first type; and a sentence in the fifth text belonging to the cluster, and a first label of the fifth text indicating that the type of the behavior of the first user is the second type;
determining, based on a quantity of second texts, a quantity of third texts, a quantity of fourth texts, and a quantity of fifth texts, a correlation coefficient between the cluster and the first label of the first text to which the sentence in the cluster belongs; and
determining the second score of the cluster based on the correlation coefficient.

In an aspect, the training module is configured to:
input, for each of the text pairs, the conversation record and the text pair into the first model for prediction, to obtain a first probability of a first text having a high first score in the text pair and a second probability of a first text having a low first score in the text pair;
input the conversation record and the text pair into a second model for prediction, to obtain a third probability of the first text having a high first score in the text pair and a fourth probability of the first text having a low first score in the text pair;
determine a fifth probability of the text pair based on a ratio of the first probability to the third probability and a ratio of the second probability to the fourth probability, the fifth probability indicating a probability that the first text having a high first score is superior to the first text having a low first score in the text pair;
determine a loss of the first model based on fifth probabilities of the plurality of text pairs; and
adjust a parameter of the first model based on the loss.

The model training apparatus 400 provided in an aspect of this disclosure may be used as an execution entity of the model training method shown in FIG. 1, and therefore, a function implemented by the model training apparatus in FIG. 1 can be implemented. Because principles are the same, details are not described again.

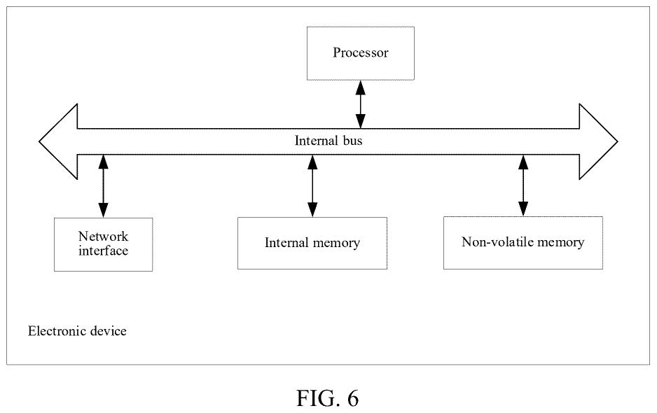

An aspect of this disclosure further provides a text generation apparatus. FIG. 5 is a schematic diagram of a structure of a text generation apparatus 500 according to an aspect of this disclosure. The apparatus 500 includes:
a second generation module 510, configured to generate a sixth text based on a first model and a conversation record of a second user, the sixth text being configured for describing a behavior tendency of the second user;
a third generation module 520, configured to extract a first phrase from a sentence in the sixth text, and generate a first question text based on the sentence to which the first phrase belongs, the first question text being configured for describing a question with the first phrase as an answer;
a checking module 530, configured to check the first phrase based on the first question text; and
a fourth generation module 540, configured to obtain a seventh text based on a check result of the first phrase.

In an aspect, the checking module is configured to:
obtain, from the conversation record of the second user, an eighth text configured for answering the first question text;
check, by using a third model, whether the first phrase is obtained from the eighth text; and
determine, if the first phrase is obtained from the eighth text, that the first phrase passes the check; or
determine, if no first phrase is obtained from the eighth text, that the first phrase does not pass the check.

In an aspect, the sixth text is obtained by inputting a first prompt and the conversation record of the second user into the first model.

The fourth generation module is configured to:
generate a first instruction based on the first phrase if the first phrase does not pass the check, the first instruction being configured for instructing to generate the seventh text that does not include the first phrase;
add the first instruction into the first prompt, to obtain a second prompt; and
input the second prompt and the conversation record of the second user into the first model, to obtain the seventh text.

The text generation apparatus 500 provided in an aspect of this disclosure may be used as an execution entity of the text generation method shown in FIG. 2, and therefore, a function implemented by the text generation apparatus in FIG. 2 can be implemented. Because principles are the same, details are not described again.

FIG. 6 is a schematic diagram of a structure of an electronic device according to an aspect of this disclosure. Refer to FIG. 6. On a hardware level, the electronic device includes a processor, and further includes an internal bus, a network interface, and a memory in some aspects. The memory may include an internal memory, for example, a high-speed random access memory (RAM), or may further include a non-volatile memory, for example, at least one magnetic disk memory. The electronic device may further include hardware required by another service.

Processing circuitry, such as the processor, the network interface, and the memory may be connected to each other by using an internal bus. The internal bus may be an industry standard architecture (ISA) bus, a peripheral component interconnect (PCI) bus, an extended industry standard architecture (EISA) bus, or the like. The bus may be classified as an address bus, a data bus, a control bus, or the like. For ease of description, only one bidirectional arrow is used for representation in FIG. 6, but this does not indicate that there is only one bus or only one type of bus.

The memory, such as a non-transitory computer-readable storage medium, is configured to store a program. Specifically, the program may include program code, and the program code includes computer operation instructions. The memory may include an internal memory and a non-volatile memory, and provide instructions and data for the processor.

The processor reads a corresponding computer program from the non-volatile memory into the internal memory and then runs the computer program, to form a model training apparatus on a logical level. The processor executes the program stored in the memory, and is specifically configured to perform the following operations:
generating a plurality of first texts based on a first model and a conversation record of a first user, the first text being configured for describing a behavior tendency of the first user;
determining a first score of each of the first texts based on behavior data of the first user;
combining the plurality of first texts based on the first score of each of the first texts, to obtain a plurality of text pairs; and
training the first model based on the plurality of text pairs.

Alternatively, the processor reads a corresponding computer program from the non-volatile memory into the internal memory and then runs the computer program, to form a text generation apparatus on a logical level. The processor executes the program stored in the memory, and is specifically configured to perform the following operations:
generating a sixth text based on a first model and a conversation record of a second user, the sixth text being configured for describing a behavior tendency of the second user;
extracting a first phrase from a sentence in the sixth text, and generating a first question text based on the sentence to which the first phrase belongs, the first question text being configured for describing a question with the first phrase as an answer;
checking the first phrase based on the first question text; and
obtaining a seventh text based on a check result of the first phrase.

The foregoing method performed by the model training apparatus disclosed in the aspect shown in FIG. 1 of this disclosure or the foregoing method performed by the text generation apparatus disclosed in the aspect shown in FIG. 2 of this disclosure may be applied to the processor or may be implemented by the processor. The processor may be an integrated circuit chip, and has a signal processing capability. During implementation, operations of the foregoing method may be completed by using an integrated logic circuit of hardware in the processor or instructions in a form of software. The processor may be a general-purpose processor, including a central processing unit (CPU), a network processor (NP), and the like. The processor may alternatively be a digital signal processor (DSP), an application-specific integrated circuit (ASIC), a field programmable gate array (FPGA) or another programmable logic device, a discrete gate or transistor logic device, or a discrete hardware component, and may implement or perform the methods, operations, and logic block diagrams that are disclosed in aspects of this disclosure. The general-purpose processor may be a microprocessor, or the processor may be any conventional processor or the like. The operations of the methods disclosed with reference to aspects of this disclosure may be directly performed and completed by using a hardware decoding processor, or may be performed and completed by using a combination of hardware and software modules in the decoding processor. The software module may be located in a storage medium that is mature in the art, for example, a random access memory, a flash memory, a read-only memory, a programmable read-only memory, an electrically erasable programmable memory, or a register. The storage medium is located in the memory. The processor reads information in the memory and completes the operations of the methods in combination with hardware thereof.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The electronic device may further perform the method in FIG. 1, and implement functions of the model training apparatus in the aspect shown in FIG. 1. Alternatively, the electronic device may perform the method in FIG. 2, and implement functions of the text generation apparatus in aspects shown in FIG. 2 and FIG. 3. Details are not described herein again in this aspect of this disclosure.

The electronic device in this disclosure does not exclude, for example, a logic device or a software-hardware combination. In other words, execution entities of the following processing procedures are not limited to logic units and may alternatively be hardware or logic devices.

An aspect of this disclosure further provides a computer-readable storage medium, such as a non-transitory computer-readable storage medium. The computer-readable storage medium has one or more programs stored thereon. The one or more programs include instructions. When the instructions are executed by a portable electronic device including a plurality of applications, the portable electronic device is enabled to perform the method in the aspect shown in FIG. 1, and is specifically configured to perform the following operations:
generating a plurality of first texts based on a first model and a conversation record of a first user, the first text being configured for describing a behavior tendency of the first user;
determining a first score of each of the first texts based on behavior data of the first user;
combining the plurality of first texts based on the first score of each of the first texts, to obtain a plurality of text pairs; and
training the first model based on the plurality of text pairs.

Alternatively, when the instructions are executed by a portable electronic device including a plurality of applications, the portable electronic device is enabled to perform the method in the aspect shown in FIG. 2, and is specifically configured to perform the following operations:
generating a sixth text based on a first model and a conversation record of a second user, the sixth text being configured for describing a behavior tendency of the second user;
extracting a first phrase from a sentence in the sixth text, and generating a first question text based on the sentence to which the first phrase belongs, the first question text being configured for describing a question with the first phrase as an answer;
checking the first phrase based on the first question text; and
obtaining a seventh text based on a check result of the first phrase.

An aspect of this disclosure further provides a computer program product. The computer program product includes a non-transitory computer-readable storage medium having a computer program stored thereon. The computer program is executable to enable a computer to perform some or all of operations in the model training method or in the text generation method provided in aspects of this disclosure.

The foregoing descriptions are merely examples of this disclosure and are not intended to limit the protection scope of this disclosure. Any modification, equivalent replacement, or improvement made without departing from the spirit and principle of this disclosure shall fall within the protection scope of this disclosure.

The system, the apparatus, the module or the unit described in the foregoing aspects may be specifically implemented by processing circuitry, such as a computer chip or an entity, or implemented by a product having a function. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or a combination of any of the devices.

The computer-readable medium includes a non-volatile medium and a volatile medium, a removable medium and a non-removable medium, which may implement information storage of information by using any method or technology. The information may be computer-readable instructions, a data structure, a program module, or other data. Examples of a storage medium of a computer include but are not limited to a phase-change memory (PRAM), a static random access memory (SRAM), a dynamic random access memory (DRAM), or other types of random access memory (RAM), a read-only memory (ROM), an erasable programmable read-only memory (EEPROM), a flash memory or another storage technology, a compact disc read-only memory (CD-ROM), a digital versatile disc (DVD) or another optical storage, a cartridge tape, a magnetic tape, a magnetic disk storage or another magnetic storage device, or any other non-transmission medium, which may be configured to store information accessible by a computing device. According to limitations of this disclosure, the non-transitory computer-readable medium does not include transitory computer-readable media, for example, a modulated data signal and a modulated carrier.

The terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Unless otherwise specified, an element limited by “include a/an . . . ” does not exclude other same elements existing in the process, the method, the article, or the device that includes the element. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Aspects of this disclosure are described in a progressive manner, for same or similar parts in aspects, reference is made to these aspects, and descriptions of each aspect focus on a difference from other aspects. A system aspect is basically similar to a method aspect, and therefore is described briefly; for related parts, reference may be made to partial descriptions in the method aspect.

What is claimed is:

1. A model training method, comprising:
generating a first set of texts based on a conversation of a first user, the first set of texts indicating a tendency of the first user in response to the conversation;
determining a first score of each text of the first set of texts based on behavior data of the first user, the first score indicating a correlation between the tendency of the first user and a behavior of the first user in response to the conversation;
combining the first set of texts based on the first score of each text, to obtain a plurality of pairs of texts; and
training a first prediction model based on the plurality of pairs of texts.

2. The method according to claim 1, wherein the determining the first score comprises:
determining a first label of each text of the first set of texts based on the behavior data, the first label indicating a type of the behavior of the first user in response to the conversation;
obtaining one or more clusters based on sentences in the first set of texts; and
determining the first score of each text based on the first label and the one or more clusters.

3. The method according to claim 2, wherein the obtaining the one or more clusters comprises:
obtaining sentence vectors of the sentences in the first set of texts; and
clustering the sentences into the one or more clusters based on similarities between the sentence vectors of the sentences.

4. The method according to claim 3, the method further comprising:
determining a second score of a cluster of the one or more clusters, the second score indicating a correlation between a text in a sentence of the cluster and the first label; and
determining a sum of second scores of the one or more clusters to which the sentences in the first set of texts belong.

5. The method according to claim 4, wherein the determining the second score of the cluster further comprises:
determining, from the first set of texts, one or more key texts corresponding to the cluster,
determining, based on a quantity of the one or more key texts, a correlation coefficient between the cluster and the first label of the text in the sentence included in the cluster; and
determining the second score of the cluster based on the correlation coefficient.

6. The method according to claim 1, wherein the training the first prediction model further comprises:
inputting the conversation and the plurality of pairs of texts into the first prediction model to obtain a probability range, the probability range having a first upper limit and a first lower limit;
inputting the conversation and the plurality of pairs of texts into a second prediction model to obtain a second probability range, the second probability range having a second upper limit and a second lower limit;
determining a third probability based on a ratio of the first upper limit and the second upper limit, and a ratio of the first lower limit and the second lower limit;
determining a loss of the first prediction model based on the third probability; and
adjusting parameters of the first prediction model based on the loss.

7. The method according to claim 1, the method further comprising:
generating a second set of texts based on the first prediction model and a conversation of a second user, the second set of texts indicating a tendency of the second user;
extracting a first phrase from a sentence in the second set of texts, and generating a first question text based on the sentence, the first question text indicating a question with the first phrase as an answer;
checking the first phrase based on the first question text; and
obtaining a text based on the checking.

8. The method according to claim 7, wherein the checking the first phrase further comprises:
obtaining, from the conversation of the second user, a first text corresponding to an answer to the first question text; and
determining, by using a third prediction model,
the first phrase passes the checking when the first phrase matches the first text corresponding to the answer to the first question text, and
the first phrase does not pass the checking when the first phrase does not match the first text corresponding to the answer to the first question text.

9. The method according to claim 8, the method further comprising:
generating a first instruction when the first phrase does not pass the check, the first instruction being configured to cause a second text without the first phrase to be generated; and
inputting the first instruction and the conversation of the second user into the first prediction model to obtain the second text corresponding to the answer to the first question text.

10. A model training apparatus, the apparatus comprising:
processing circuitry configured to
generate a first set of texts based on a conversation of a first user, the first set of texts indicating a tendency of the first user in response to the conversation;
determine a first score of each text of the first set of texts based on behavior data of the first user, the first score indicating a correlation between the tendency of the first user and a behavior of the first user in response to the conversation;
combine the first set of texts based on the first score of each text, to obtain a plurality of pairs of texts; and
train a first prediction model based on the plurality of pairs of texts.

11. The apparatus according to claim 10, wherein the processing circuitry is configured to:
determine a first label of each text of the first set of texts based on the behavior data, the first label indicating a type of the behavior of the first user in response to the conversation;
obtain one or more clusters based on sentences in the first set of texts; and
determine the first score of each text based on the first label and the one or more clusters.

12. The apparatus according to claim 11, wherein the processing circuitry is configured to:
obtain sentence vectors of the sentences in the first set of texts; and
cluster the sentences into the one or more clusters based on similarities between the sentence vectors of the sentences.

13. The apparatus according to claim 12, wherein the processing circuitry is configured to:
determine a second score of a cluster of the one or more clusters, the second score indicating a correlation between a text in a sentence of the cluster and the first label; and
determine a sum of second scores of the one or more clusters of to which the sentences in the first set of texts belong.

14. The apparatus according to claim 13, wherein the processing circuitry is configured to:
determine, from the first set of texts, one or more key texts corresponding to the cluster,
determine, based on a quantity of the one or more key texts, a correlation coefficient between the cluster and the first label of the text in the sentence included in the cluster; and
determine the second score of the cluster based on the correlation coefficient.

15. The apparatus according to claim 10, wherein the processing circuitry is configured to:
input the conversation and the plurality of pairs of texts into the first prediction model to obtain a probability range, the probability range having a first upper limit and a first lower limit;
input the conversation and the plurality pair of texts into a second prediction model to obtain a second probability range, the second probability range having a second upper limit and a second lower limit;
determine a third probability based on a ratio of the first upper limit and the second upper limit and a ratio of the first lower limit and the second lower limit;
determine a loss of the first prediction model based on the third probability; and
adjust parameters of the first prediction model based on the loss.

16. The apparatus according to claim 10, wherein the processing circuitry is configured to:
generate a second set of texts based on the first prediction model and a conversation of a second user, the second set of texts indicating a tendency of the second user;
extract a first phrase from a sentence in the second set of texts, and generating a first question text based on the sentence, the first question text indicating a question with the first phrase as an answer;
check the first phrase based on the first question text; and
obtain a text based on the check.

17. The apparatus according to claim 16, wherein the processing circuitry is configured to:
obtain, from the conversation of the second user, a first text corresponding to an answer to the first question text; and
determine, by using a third prediction model,
the first phrase passes the checking when the first phrase matches the first text corresponding to the answer to the first question text, and
the first phrase does not pass the checking when the first phrase does not match the first text corresponding to the answer to the first question text.

18. The apparatus according to claim 17, wherein the processing circuitry is configured to:
generate a first instruction when the first phrase does not pass the check, the first instruction being configured to cause a second text without the first phrase to be generated; and
input the first instruction and the conversation of the second user into the first prediction model to obtain the second text corresponding to the answer to the first question text.

19. A non-transitory computer-readable storage medium, storing instructions which when executed by a processor cause the processor to perform:
generating a first set of texts based on a conversation of a first user, the first set of texts indicating a behavior tendency of the first user in response to the conversation;
determining a first score of each text of the first set of texts based on behavior data of the first user, the first score indicating a correlation between the tendency of the first user and a behavior of the first user in response to the conversation;
combining the first set of texts based on the first score of each text, to obtain a plurality of pairs of texts; and
training a first prediction model based on the plurality of pairs of texts.

20. The non-transitory computer-readable storage medium according to claim 19, wherein the determining the first score further comprises:
determining a first label of each text of the first set of texts based on the behavior data, the first label indicating a type of the behavior of the first user in response to the conversation;
obtaining one or more clusters based on sentences in the first set of texts; and
determining the first score of each text based on the first label and the one or more clusters.
